(19) United States
(12) Patent Application Publication
(10) Pub. No.: US 2006/0086454 A1
(43) Pub. Date: Apr. 27, 2006

(54) Methods and apparatus to create finished surfaces on vinyl slats

(76) Inventors: Cyrus A. Jabbari, Vienna, VA (US); Edwin Morales, Fresno, TX (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/974,136

(22) Filed: Oct. 27, 2004

(51) Int. Cl. B44C 1/165; B32B 37/00; B29C 65/00

(52) U.S. Cl. 156/230; 156/580; 156/555

(57) ABSTRACT

The present invention comprises a slat finishing machine having a laminating subassembly for selectively disposing colorants onto slats, and an embossing subassembly for selectively creating textured surfaces on slats. The present invention also comprises methods for finishing slats.

### BACKGROUND OF THE INVENTION

1. Field of the Invention

The present invention relates generally to coverings for windows and the like, and in particular, to methods and apparatus for creating finished surfaces on vinyl slats.

2. Discussion of the Related Art

Blinds are commonly used as treatments for covering openings, windows, doors, and the like. Blinds are comprised of slats, which serve several purposes. Typically, the slats are adjustable to selectively filter light or air, for example. Blinds are also used for aesthetic or decorative purposes.

Slats can be formed from a number of materials including wood, metal, poly vinyl chloride (PVC) or similar materials. PVC slats are typically formed by selectively extruding and curing molten material to the desired shape. It is known to create unique surfaces on the slats, such as intricate textured, patterned or colored surfaces. However, a need exists for a device which can, during the curing process, effectively mold and color the slat surfaces.

### SUMMARY OF THE INVENTION

Accordingly, the present invention comprises methods and apparatus for creating finished surfaces on vinyl slats or blinds. The present invention comprises a laminating subassembly for selectively disposing colorants onto the blinds, and an embossing subassembly for selectively creating textured surfaces on the blinds.

These and other objects and advantages of the present invention will be classified in the following description of the preferred embodiment in connection with the drawings, the disclosure and the appended claims, wherein like reference numerals represent like elements throughout. The drawings constitute a part of this application and include exemplary embodiments of the present invention and illustrate various features thereof.

### BRIEF DESCRIPTION OF THE DRAWINGS

FIG. 1 is a front perspective view of a slat finishing machine exemplifying the present invention.

FIG. 2 is a rear perspective view of the slat finishing machine.

FIG. 3 is a perspective view of a film feeder subassembly of the slat finishing machine.

FIG. 4 is an enlarged, partially cut away perspective view of a laminating subassembly and an embosser subassembly of the slat finishing machine.

FIG. 5 is an enlarged, cut away, front perspective view of the laminating subassembly of the slat finishing machine.

FIG. 6 is an enlarged, cut away front perspective view of the embosser subassembly of the slat finishing machine.

### DETAILED DESCRIPTION OF THE PREFERRED EMBODIMENTS

While the present invention may be embodied in many different forms, there is shown in the drawings and discussed herein a few specific embodiments with the understanding that the present disclosure is to be considered only as an exemplification of the principles of the invention and is not intended to limit the invention to the embodiments illustrated.

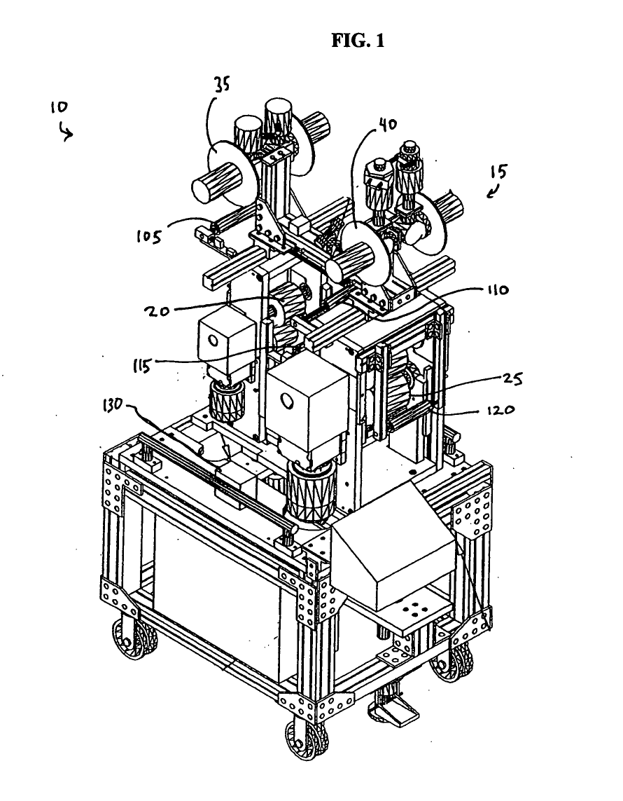

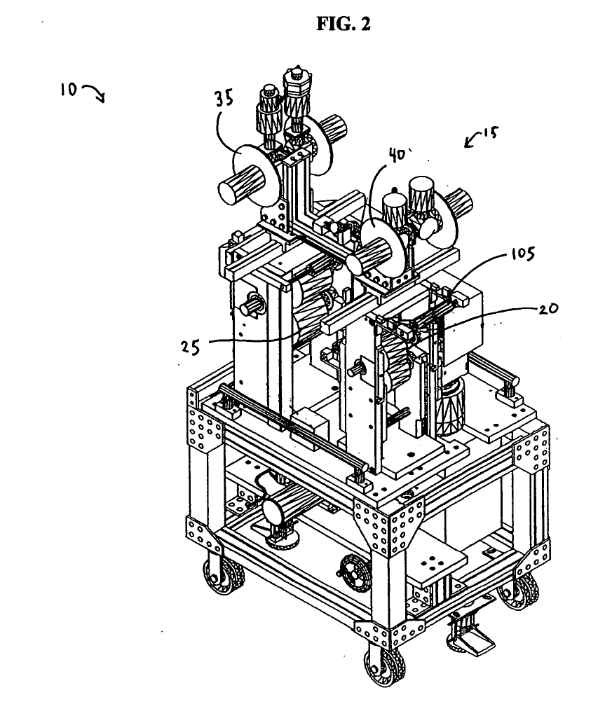

Referring to the drawings in greater detail, FIGS. 1 and 2 illustrate an exemplary embodiment of the slat finishing machine 10 of the present invention. The machine 10 generally comprises a film feeder subassembly 15, a laminating subassembly 20, and an embosser subassembly 25.

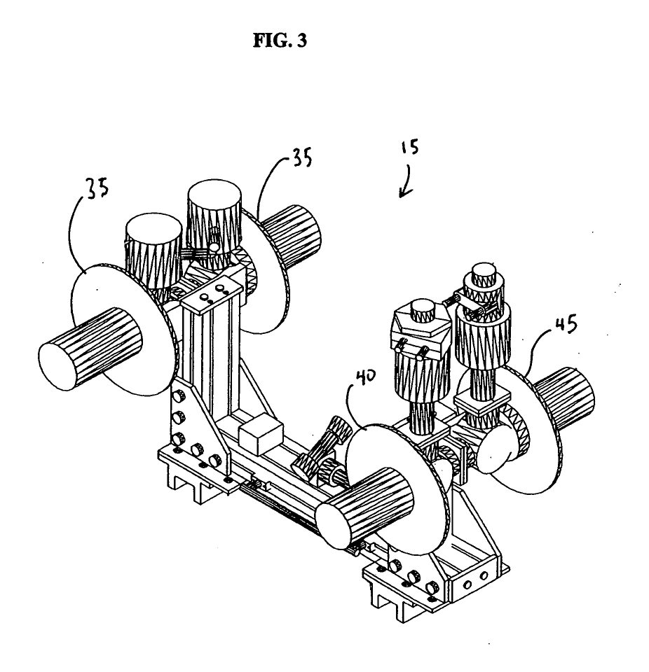

Referring to FIG. 3, the film feeder subassembly 15 comprises first and second dispensing rollers 30, 35, and corresponding first and second take up rollers 40, 45. Each of the dispensing rollers 30, 35 is configured to receive a roll of film 50 (i.e., the film 50 is wound around the rollers). As discussed more below, during operation as the dispensing rollers 30, 35 and the take up rollers 40, 45 rotate, the film 50 travels from the dispensing rollers 30, 35 into contact with the slats 125 at the laminating subassembly 20, and the spent film 50 is then collected onto the take up rollers 40, 45.

The film 50 is preferably formed from paper or mylar. One or more colorants such as water based or solvent based ink or paint (not shown) is disposed on one side of the film 50. The colorants can be disposed on the film 50 in virtually any pattern or configuration. The colorants can be any color. As discussed more below during operation the film 50 selectively contacts the colorant, transferring the colorant to the slats.

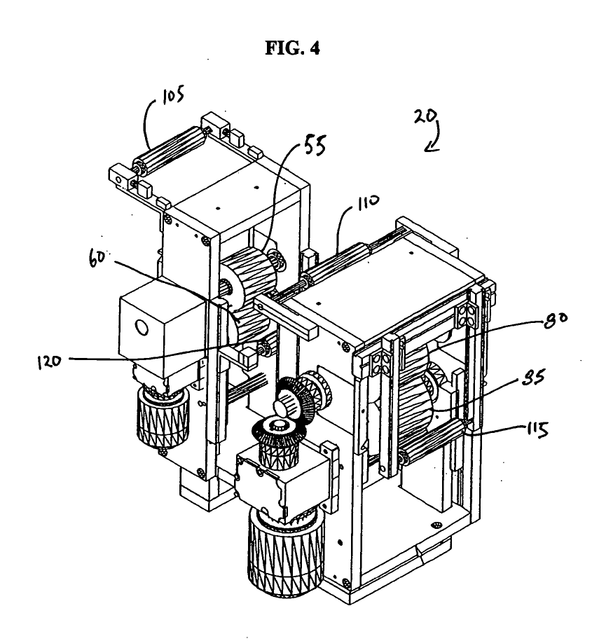

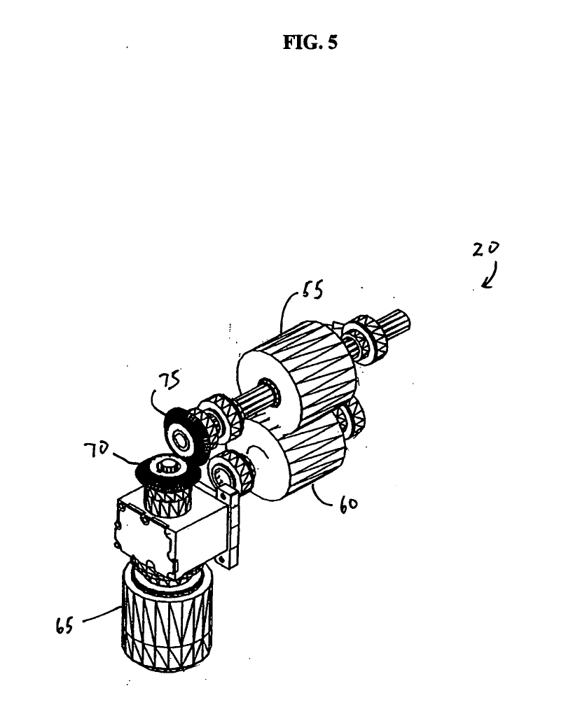

Referring to FIG. 4 and FIG. 5, the laminating subassembly 20 includes a laminating roller 55 which is in close proximity to a lower support roller 60. In a preferred embodiment the laminating roller 55 and the support roller 60 each is 4 inches in diameter. A gear motor 65 and mating gears 70, 75 are provided to drive the laminating roller 55. In a preferred embodiment, the laminating roller 55 and the support roller 60 are prevented from contacting one another by an electronic contact device (not shown), so as to reduce potential for operator injury. In this embodiment, a lift mechanism may be located below the lower support roller 60 to raise and/or lower the lower support roller 60 to achieve the desired spacing between the laminating roller 55 and the lower support roller 60.

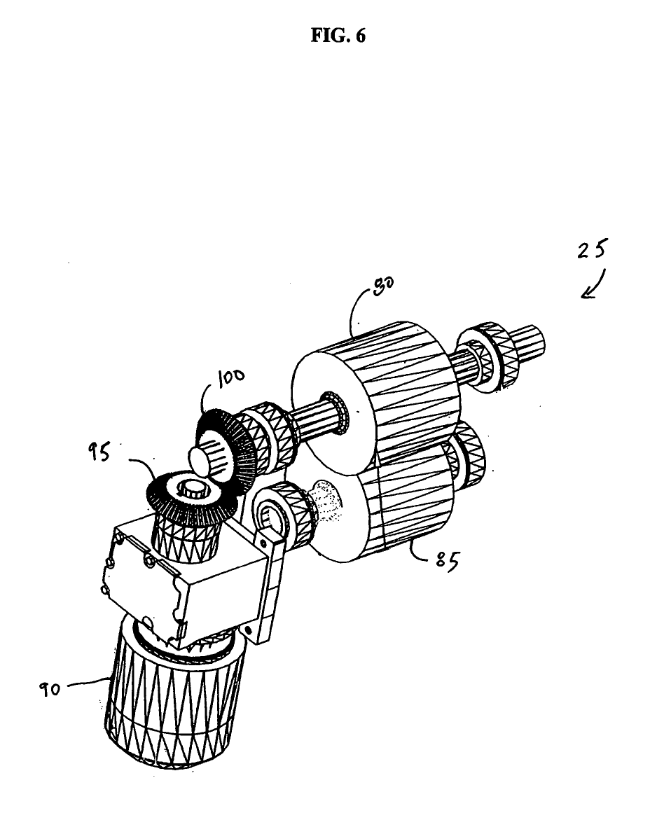

Referring to FIG. 4 and FIG. 6, the embossing subassembly 25 includes an embossing roller 80 which is in close proximity to a lower support roller 85. A lift mechanism located below the lower support roller 85 is used to raise and/or lower the lower support roller 85 to achieve the desired spacing between the embossing roller 80 and the lower support roller 85. The spacing will depend upon the thickness of the slat being embossed, as well as the texture or pattern that is to be made on the surface of the slat. In a preferred embodiment the embossing roller 80 is 6 inches to 10 inches in diameter and the support roller 85 is 6 inches in diameter. A gear motor 90 and a pair of mating gears 95, 100 are provided to drive the embossing roller 80. In a preferred embodiment the outer surface of the embossing roller 80 can be provided with a textured or patterned surface, which, as discussed more below, can be utilized during operation to create a corresponding textured or patterned surface on the slats.

Referring to FIGS. 1-2 and 4, a series of guide rollers 105, 110, 115, 120 are mounted to the machine 10 in working relationship with the film feeder subassembly 15. Referring to FIG. 3 and FIG. 4, a roll of the tape 50 is loaded onto the dispensing roller that is located on the operating side of an extruder machine from which slat 125 is fed into machine 10. Tape 50 is then routed over guide roller 105 and under the laminating roller 55, underneath the film releasing roller 120, and onto the take up roller 45. The dispensing rollers 35 are provided on both sides of the machine 10 to facilitate the operation from either side of the machine (depending upon the location of the extruder machine) and the preparation and mounting of a new roll of film 50 before the roll in use is finished. In addition, the position of the control panel for the machine 10 is adjustable to provide the ability to operate and make adjustments on the machine 10 from either side of the machine 10.

Referring to FIGS. 1-2 and FIG. 4, in operation following extrusion a ductile PVC slat 125 is fed into the machine 10 and travels from the laminating subassembly 20 to the embossing subassembly 25. More particularly, the slat 125 travels between the laminating roller 55 and the lower support roller 60 with the film 50 positioned between the laminating roller and the film 50. The laminating roller 55 selectively engages the film 50 to bring the film 50 into contact with the slat. Upon contact the laminating roller 55 transfers the colorant from the film 50 onto the slat 125. The slat 125 then travels between the embossing roller 80 and the support roller 85. Upon contact the embossing roller 85 deforms the slat 125, leaving a mirror image of the embossing roller surface on the slat 125. Referring to FIG. 1, an emergency kill switch 130 is also provided to allow the machine 10 to be turned off quickly by an operator.

Although it is believed to be apparent from the foregoing discussion, the present invention also includes a method for creating a finished surface on vinyl slats. The method comprises the steps of bringing the slat into contact with an embossing roller to deform the slat; disposing colorant onto a film; and using a laminating roller to bring the slat into contact with the film to transfer the colorant from the film onto the slat.

Although the foregoing detailed description of the present invention has been described by reference to two exemplary embodiments, and the best mode contemplated for carrying out the present invention has been shown and described, it will be understood that modification or variations in the structure and arrangement of this embodiment other than those specifically set forth herein may be achieved by those skilled in the art and that such modifications are to be considered as being within the overall scope of the present invention. Therefore, it is contemplated to cover the present invention and any and all modifications, variations, equivalents that fall with in the true spirit and scope of the underlying principles disclosed and claimed herein. Consequently, the scope of the present invention is intended to be limited only by the attached claims.

What is claimed is:

1. An apparatus for creating a finished surface on a slat, comprising:
(a) a film having a colorant disposed on the film; and
(b) a laminating roller for selectively bringing the film into contact with the slat to transfer the colorant from the film to the slat.

2. The apparatus of claim 1, further comprising an embossing roller for selectively deforming the slat.

3. The apparatus of claim 2, wherein the embossing roller is positioned in series with the laminating roller.

4. The apparatus of claim 1, further comprising a film feeder having a dispensing roller and a take up roller, wherein the film travels from the dispensing roller, into contact with the slat, and then to the take up roller.

5. The apparatus of claim 4, wherein the dispensing roller comprises a pair of rollers provided on two sides of the apparatus.

6. The apparatus as claimed in claim 1, further comprising an adjustably positionable control panel.

7. An apparatus for creating a finished surface on a slat, comprising:
(a) a film feeder for selectively dispensing film, the film having a colorant disposed on at least a portion of the film;
(b) a laminating roller for selectively transferring the colorant from the film to the slat; and
(c) an embossing roller for selectively deforming the slat.

8. A method for creating a finished surface on vinyl slats, comprising:
(a) Disposing colorant onto a film; and
(b) Providing a laminating roller to bring the slat into contact with the film to transfer the colorant from the film onto the slat.

9. The method of claim 8, further comprising the step of bringing the slat into contact with an embossing roller to deform the slat.
